(19) United States
(12) Patent Application Publication
(10) Pub. No.: US 2002/0133334 A1
(43) Pub. Date: Sep. 19, 2002

(54) Time scale modification of digitally sampled waveforms in the time domain

(76) Inventors: Geert Coorman, Kortrijk (BE); Peter Rutten, Gent (BE); Jan DeMoortel, Rollegem (BE); Bert Van Coile, Brugge (BE)

Correspondence Address: BROMBERG & SUNSTEIN LLP, 125 SUMMER STREET, BOSTON, MA, 02110-1618, US

(21) Appl. No.: 09/776,018

(22) Filed: Feb. 2, 2001

(51) Int. Cl. G10L 19/14

(52) U.S. Cl. 704/211

(57) ABSTRACT

A system is disclosed for generating a time scale modification of a digital waveform. A digital waveform provider produces an input digital waveform at a first time resolution, the digital waveform being a sequence of overlapping speech segment windows. A time-domain time scale modification process overlap adds selected windows from the input digital waveform to create an output digital waveform representing a time scale modification of the input digital waveform. The process operates at a second time resolution lower than the first time resolution to determine the relative positions between adjacent windows in the output digital waveform.

### FIELD OF THE INVENTION

The present invention is generally related to signal processing, and more specifically, to a speech rate modification system that can be used in either a stand-alone device, or included in other devices such as text-to-speech systems or audio coders.

### BACKGROUND ART

Time scale modification (TSM) of an audio signal is a process whereby such a signal is compressed or expanded in time according to a selected time warp function, while preserving (within practical limits) all perceptual characteristics of the audio signal except its timing. Time scale modification of speech signals is used in many different applications ranging from synchronization of sounds, to video over fast playback in digital answering machines, to high speaking rate text-to-speech systems (e.g. for the blind). Time scale modification can be done either in the frequency domain (as described in M. Portnoff, “Time-Scale modification of Speech Based on Short-Time Fourier Analysis”, IEEE Transactions on Acoustics, Speech, and Signal Processing, Vol. 29, No. 3, June 1981), in the time domain (described in W. Verhelst. & M. Roelands, “An overlap-add technique based on waveform similarity (WSOLA) for high quality time-scale modification of speech”, IEEE International Conference on Acoustics, Speech, and Signal Processing Conference proceedings, pp. 554-557 vol.2, 1993), or in the time-frequency domain (described in H. Kawahara, I. Masuda-Katsuse, A. De Chevaigné, “Restructuring speech representations using a pitch-adaptive time-frequency smoothing and an instantaneous-frequency-based F0 extraction: Possible role of a repetitive structure in sounds”, Speech Communication Vol. 27, pp. 187-207, 1999), all of which references are hereby incorporated herein by reference. The following discussion considers time domain methods of TSM, most of which are based on an overlap-and-add scheme as will be described.

An original speech signal of length N can be described as x(n) n=0,1, . . . , N −1. Modifying x(n) by a time warp function τ(n) that maps the time index n to the warped index τ(n) produces a new speech signal y(n) n=0,1, . . . , M −1 that corresponds to the time-scale modification (TSM) of x(n). Many applications, such as fast playback, use a linear time-warp function τ(n)=α·n with αthe rate modification factor. If α<1, then we speak about time scale compression (M<N), otherwise, if α>1, we speak about time scale expansion (M>N). Many time-domain TSM methods divide the signal x(n) into equal length frames, and reposition these frames before reconstructing them in order to realize or approximate the time warp function τ(n). These frames are usually longer than a pitch period and shorter than a phoneme. Some time scale modification techniques do not use equal length frames, but adapt their lengths to the local characteristics of the speech signal as described in U.S. Pat. No. 5,920,840 to Satyamurti et al.

The simplest TSM technique is the sampling method that divides the speech signal x(n) into non-overlapping equal length frames, and repositions these frames in order to realize the time warp function τ(n). This can result in discontinuities occurring at frame boundaries, which strongly degrades the quality of the time scaled speech signal. These signal discontinuities in the time modified speech signal can be reduced by dividing x(n) into overlapping frames (windowed speech segments), and repositioning them before overlap-and-add (OLA) rather than simply abutting them. This leads to the so-called weighted overlap-and-add TSM method described in L. R. Rabiner & R. W. Schafer, “Digital Processing of Speech Signals”, Englewood Cliffs: NJ: Prentice-Hall, 1978, incorporated herein by reference. In other words, the weighted OLA method consists of cutting out windowed segments of speech from the source signal x(n) around the points τ⁻¹ (Tₖ), and repositioning them at corresponding synthesis instants Tₖ before overlap-adding them to obtain the time scaled signal y(n). This technique is computationally simple, but introduces pitch discontinuities, leading to quality degradation because the overlapping frames do not share any reasonable phase correspondence.

The phase mismatch problem was first tackled by means of a computationally expensive iterative procedure that reconstructed the phase information from the redundancy of the ST-Fourier magnitude spectrum. More recently, the synchronized overlap-and-add (SOLA) TSM technique was introduced to resolve the phase mismatch between overlapping segments. The SOLA method is robust since it does not require iterations, pitch calculation, or phase unwrapping. Since its introduction, many different variations of SOLA have been developed. All these OLA-based methods optimize the phase-match or waveform similarity between the windowed speech segments in the region of overlap. This optimization is performed by allowing a small deviation Δ (expressed in number of samples) on the positions of the windowed speech segments determined by the time warping function τ(n). An optimal deviation Δₒₚₜ is searched either for the position where a new windowed speech segment is added to the resulting signal stream, (i.e. output synchronization as in SOLA), or for the window position in the original signal x(n) (i.e., input synchronization as in WSOLA).

Optimization of the deviation Δ is done by synchronizing the overlapping windowed speech segments (or frames) to increase the waveform similarity in the regions of overlap according to a certain criterion (i.e., synchronized OLA).

Typically, the optimization of the waveform similarity is by means of an exhaustive search in a certain small interval that may be called the “optimization interval”. In other words, the deviation Δwill be restricted to vary in a certain interval, which we denote as 2Δ_{M}. It has been reported that an increase of the sample rate (i.e. time resolution) prior to synchronization and overlap-and-add may improve the speech quality. Several criteria have been used to find the optimal deviation Δ_{Opt} including cross-correlation, normalized cross-correlation, cross average magnitude difference function (AMDF), and mean absolute error (MAE). All of those methods search for an optimal waveform similarity and are computationally expensive.

FIG. 1 is a general block diagram of a conventional time scale modification system embedded in an application. The speech rate modification system can form part of a larger system, such as a text-to-speech system, or a speech synchronization system. A speech sample provider 11 feeds speech waveforms at an input speaking rate to a time scale modifier 13. The speech sample provider 11 can be any device that contains or generates digital speech waveforms. A time warp function 12 gives information to the time scale modifier 13 about the local rate modification factor at any time instant. The time scale modifier 13 modifies the timing of the input speech by means of an overlap-and-add method as described above, and generates speech at an output speaking rate. The time warped speech waveform is than fed to a speech sample generator 14 that can be a DAC, an effect processor, a digital or analog memory, or any other system that is able to handle digital waveforms.

Typical functional blocks of the time scale modifier 13 are given in FIG. 2, which shows an input buffer 21 and an output buffer 22 together with a synchronizer 23 and an overlap-and-add process 24. A time scale modification logic controller 25 directs the operation of each block. Depending on the time warp function τ(n) 12 in FIG. 1, the TSM controller 25 selects a frame from the input speech stream delivered by the speech sample provider 11 and stores it in the input buffer 21. The output buffer 22 contains a sequence of speech samples obtained from the overlap-and-add process 24 from the previous contents of the input buffer 21. The synchronizer 23 will, according to a given criterion, determine a “best” interval of overlap for the signal in the input buffer 21 or output buffer 22 and pass this information to the overlap-and-add process 24. The overlap-and-add process 24 appropriately windows and selects the samples from the buffers in order to add them. The resulting samples are shifted in the output buffer 22. The samples that are shifted out are send to the speech sample generator 14 in FIG. 1. The synchronization criterion in the synchronizer 23 can be a wide variety of techniques as described in the prior art. In most systems, the optimization interval in which the synchronizer 23 may select the “best” interval of overlap has a constant length, and is typically in the order of a large pitch period (10 to 15 ms). Recently, some techniques have been proposed to reduce the computational load of the window synchronization. Such methods make use of simple signal features in order to synchronize the windowed speech segments. Unfortunately, some such methods are not very robust.

### SUMMARY OF THE INVENTION

A representative embodiment of the present invention includes a system for generating a time scale modification of a digital waveform comprising a digital waveform provider and a time-domain time scale modification process. The digital waveform provider produces an input digital waveform at a first time resolution, the digital waveform being a sequence of overlapping speech segment windows. The time-domain time scale modification process overlap adds selected windows from the input digital waveform to create an output digital waveform representing a time scale modification of the input digital waveform. The process operates at a second time resolution lower than the first time resolution to determine the relative positions between adjacent windows in the output digital waveform.

In a further embodiment, the time scale modification process may use a digital decimation process to operate at the second time resolution. The digital decimation process may be based on a decimation factor that is a power of two. The second time resolution may be successively increased to determine the relative positions between adjacent windows in the output digital waveform, in which case, digital decimators may be used to determine the different values of the second time resolution. The decimators may be based on decimation factors that are powers of two. Interpolators may also increase the second time resolution, and the interpolators may change the second time resolution by powers of two.

In any of the above, the digital waveform provider may be a system that generates digital speech waveforms. Embodiments also include a digital waveform coder that compresses and/or decompresses speech by the use of a time scale modifier according to any of the above systems.

### BRIEF DESCRIPTION OF THE DRAWINGS

The present invention will be more readily understood by reference to the following detailed description taken with the accompanying drawings, in which:

FIG. 1 is an overview of a time scale modifier embedded in an application.

FIG. 2 illustrates the general principle of a time scale modifier.

FIG. 3 illustrates multi-resolution decomposition of speech segments.

FIG. 4 illustrates the use of multi-resolution decomposition as a speedup method in the frame synchronization process.

FIG. 5 illustrates multi-resolution decomposition with interpolation path for high quality/high resolution time scale modification.

### DETAILED DESCRIPTION OF SPECIFIC EMBODIMENTS

A basic model of speech production indicates that voiced speech signals will generally have more energy in lower frequency bands than in higher ones. The non-uniform frequency sensitivity of human hearing also suggests that phase matching of lower frequency components is more important than for higher frequency components. Therefore a good initial approximation to the auditory-based optimization problem is obtained by reducing the search for maximum waveform similarity to the lower harmonics (i.e., reducing the time resolution). This initial estimate can be further refined through a series of local searches at successively higher time resolutions.

Thus, from a perceptual point of view, minimization of the phase mismatch in the regions of overlap should take into account the strength of the spectral components present. Minimization of phase mismatch based only on the phase spectrum is not well suited for such a purpose since prominent harmonics are more significant than low energy harmonics in the calculation of phase match. In fact, the cross-correlation measurement takes spectral component strength more or less into account, because the Fourier transform (FT) of the cross-correlation of two signals is the product of the FT of one signal with the complex conjugated FT of the other signal.

Representative embodiments of the present invention provide a computationally efficient technique for time-domain time scale modification (TSM) of a sound signal, specifically, an overlap-and-add synchronization technique that is also robust. Computational efficiency is achieved by performing the synchronization of the windowed speech segments at several levels of time resolution. The first processing step consists of a global optimization at low time resolution followed by one or more local synchronization steps at successively higher time resolutions. The cascaded multi-resolution synchronization technique combines auditory knowledge with an efficient implementation. In this approach the speech signal x(n) is decomposed into several time resolution levels by means of a cascade of linear phase decimators. A cascade of decimators is also called a multistage decimation implementation, described, for example, in P. P. Vaidyanathan, “Multirate Systems and Filter Banks”, Prentice Hall, Englewood Cliffs, pp. 134-143, 1993, incorporated herein by reference.

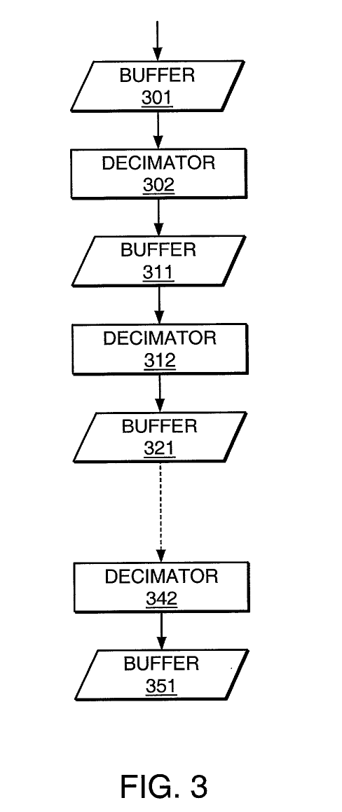

Sample rate modification techniques are well understood in the art of digital signal processing. Sample rate modification can be done entirely and efficiently in the digital domain without resorting to analog representation of the signal. A system that decimates a signal by an integer factor can be implemented as a cascade of a suitable digital low-pass filter, followed by a downsampler. Important parameters in the design of such a low-pass filter are cut-off frequency, amount of attenuation, and distortion of amplitude and phase. Any phase distortion caused by the decimation process is preferrably linear (i.e., the signal shifts in time). This implies the use of low-pass filters with linear phase in the passband. We call such sample rate reduction systems “linear phase decimators.” FIG. 3 shows such a cascade of linear phase decimators. Linear phase decimation by a factor of two can be implemented very efficiently by choosing linear phase half-band filters.

At the lowest time resolution (i.e., after K decimation stages), a global search over the entire optimization interval is performed to find the best region of overlap between two windowed segments. This optimization interval at the final decimation stage is a factor of 2^{K} smaller than the optimization interval defined at full resolution. The position of the overlapping windows is then refined by searching at higher time resolution. At the k^{th} stage (k<K), the overlap search is restricted to a smaller interval of length Lₖ that encloses the optimal deviation value that was obtained from the search at the (k+1)th stage. Δ_{Opt}^{k}, is the optimal deviation at stage k that results in an optimization of the waveform similarity measure through a local search over Lₖ samples around 2Δ_{Opt}^{k+1}, with Δ_{Opt}^{k+1} being the optimal deviation calculated at stage k+1.

By localizing the overlap searches over a smaller interval Lₖ than the optimization interval, the non-uniform frequency sensitivity of the human hearing system is incorporated in the synchronization process. The refinement of the search intervals technique ensures that lower frequencies are more significant for the phase match than higher frequencies. The relative importance between the different frequency bands is determined by the lengths of the search intervals Lₖ for the local overlap searches at higher time resolution levels. If we define the length of the optimization interval as:

$${L}_{K} = \frac{{Δ}_{M}}{{2}^{K - 1}}$$

then, the non-uniform frequency sensitivity can be expressed as:

2^{K}L_{K}>2^{K-1}L_{K-1}≧2^{K-2}L_{K-2}≧ . . . ≧L₀

In one representative embodiment, WSOLA is used for time scale modification. For speech signals at a sample rate of 22.05 kHz, the number of searches at each stage is given by:

$${L}_{k} = \{ \begin{matrix}\frac{{Δ}_{M}}{4} & k = 2 \\ 7 & k = 1 \\ 7 & k = 0\end{matrix}$$

Because of its robustness, a cross-correlation measure may suitably be used in a preferred embodiment to optimize the waveform similarity. Calculation of the cross-correlation is computationally intensive since it requires many multiplication operations. Cross-correlation computation time depends on the product of the length of the optimization interval with the length of the overlap region. Dividing the time resolution by two halves the number of samples in the overlap zone and halves the length of the optimization interval. Hence, each decimation stage increases the algorithmic efficiency of a global overlap search by a factor of four.

At the lowest time resolution (after K decimation stages), a global search is performed to optimize the waveform similarity. The computational cost for the global low time resolution search at stage K is reduced to

$$\frac{C}{{4}^{K}} ,$$

with C being the cost for searching at full time resolution. At the k^{th} stage (k<K), a small number Lₖ of local searches is done in an interval containing the optimal offset value that was obtained at the (k+1)th stage. Thus, the computational cost for the K stage multi-resolution waveform similarity optimization search may be expressed as:

$$C ( \frac{1}{{4}^{K}} + {\sum }_{k = 0}^{K - 1} \frac{{L}_{k}}{2 {Δ}_{M} {2}^{k}} )$$

The multi-resolution approach described above makes the error measure perceptually relevant, and increases the computational efficiency. A global search to minimize the phase mismatch at a low time resolution (i.e., low sample rate), followed by at least one local search at higher time resolution does indeed decrease the computation time significantly.

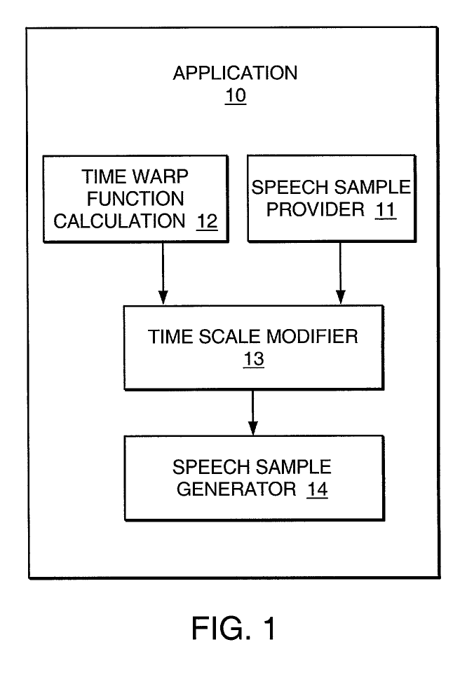

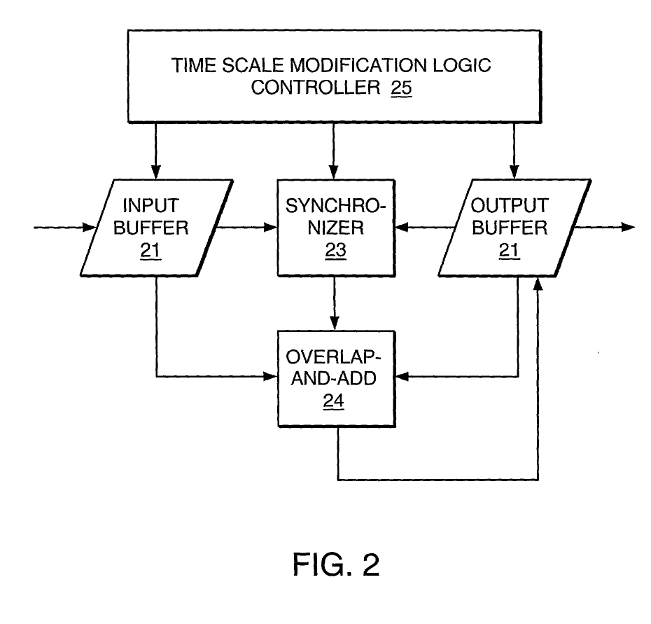

FIG. 3 is a conceptual diagram of a multi-resolution decomposition system according to a representative embodiment of the invention, which operates in a time scale modification system such as the generic one shown in FIGS. 1 and 2. The multi-resolution decomposition system receives input speech samples at a given sample rate from the speech sample provider 11 and produces a sequence of speech samples at successively lower sample rates. These samples are stored in several buffers 301, 311, 321 and 351 whose sizes are suitable for the signal processing actions (i.e., synchronization optimization and overlap-and-add for the buffer 301). The multi-resolution decomposition system in FIG. 3 also includes a series of decimation units 302, 312 and 342. In representative embodiments, the time scale modifier may be a microprocessor in combination with digital memory. Part of the memory is used to store the instructions of the microprocessor while the other part is used as processing memory (signal buffering, global and temporal variables . . . ).

In one embodiment of the system, each decimation step reduces the sample rate (and the time resolution) by a factor of two. For example, if the input signal has a sample frequency of F, then the sample frequency of the signal after one decimation stage is halved to F/2, after two decimation stages F/4 and so on. Prior to sample rate reduction, each decimation unit filters its input sample stream so that aliasing effects are negligible in the context of the synchronization process. Because a correct phase alignment between the successively decimated signal streams is very important for the local search operations, linear phase filters are preferred for low-pass filtering the speech prior to decimation. An efficient implementation of the linear phase decimator may be realized by means of a half-band low-pass filter polyphase implementation, described for example, in R. E. Crochiere & L. R. Rabiner, Multirate Digital Signal Processing, Prentice-Hall, ISBN 0-13-605162-6, 1983, incorporated herein by reference. Since the decimator output is not used for sound generation, restrictions on the decimation filter are less stringent than would be the case for audio production. This may done by a linear phase half-band digital filter. Half-band polyphase implementation requires only P multiplications and P+1 additions per output sample for a linear phase half-band filter of order 4P.

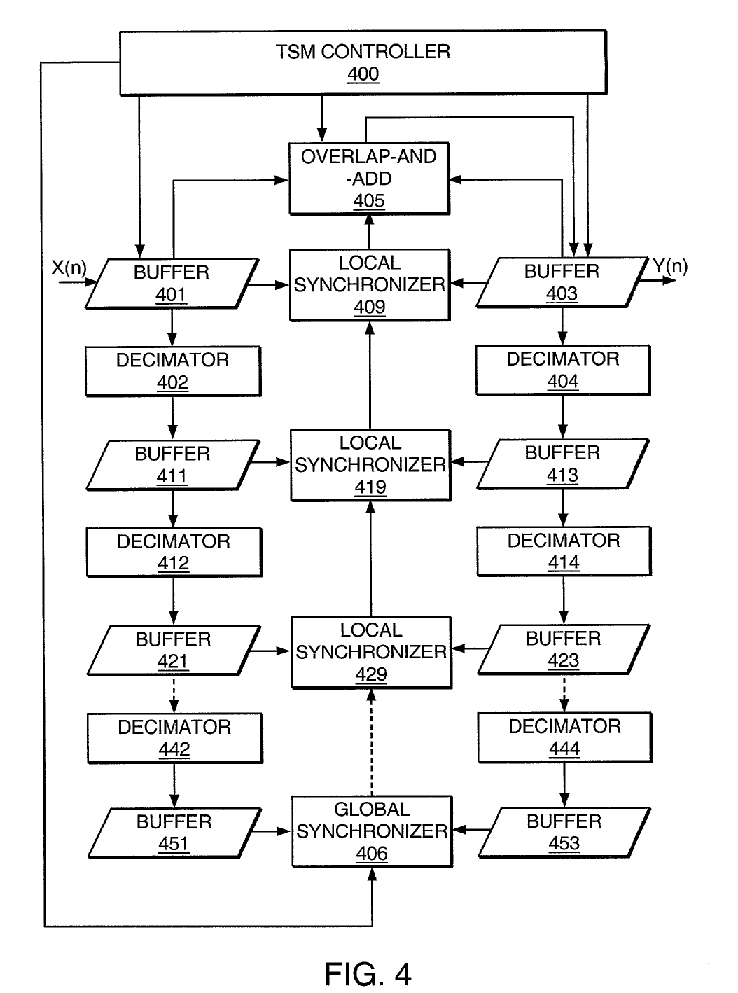

FIG. 4 illustrates multi-resolution synchronization within a typical time scale modification system according to a representative embodiment. As can be seen in FIG. 4, the multi-resolution decomposition system generates several levels of time resolution. A frame of digital waveform input signal x(n) is selected based on the time warp function and the current synthesis time, and the selected frame is put in the first input buffer 401. The first input buffer 401 should be large enough for the synchronization process (i.e., the buffer size is larger than or equal to the sum of the window length and the length of the optimization interval). A similar process occurs with the frames in the output digital waveform-a frame is taken from the end of the current output stream, and fed to a second multi-resolution decomposition system.

At the lowest resolution level, the TSM controller 400 searches lowest input buffer 451 and lowest output buffer 453 for maximum waveform similarity by performing a global optimization of the cross-correlation over the optimization interval. After the global optimization, optimization fine tuning is performed using a series of local synchronization modules 429, 419, and 409 operating on signal representations that correspond with successively higher time resolutions. After processing by the final synchronization module 409, the window positions are known with sufficient precision to overlap-and-add 405 them. The samples from first output buffer 403 are transferred to the speech sample generator 14 in FIG. 1, and the synthesized samples are shifted in.

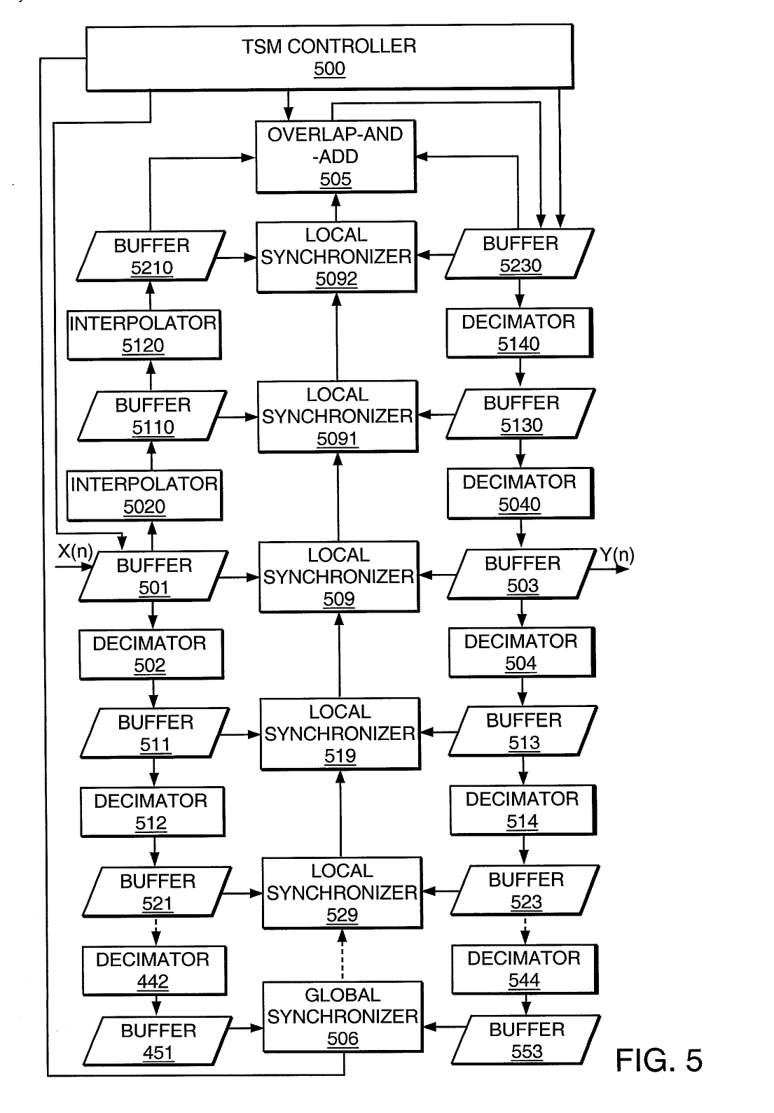

Waveform quality in some applications can benefit from synchronization and overlap-add at a time resolution higher than the input time resolution. This can be achieved in the multi-resolution decomposition system such as that as shown in FIG. 5. In FIG. 5, synchronization at time resolution levels lower than the input waveform time resolution is identical to the synchronization described in FIG. 4. After the synchronization at input resolution 509 the time resolution continues to increase above the input resolution. This is achieved by a series of interpolators. In one representative embodiment of the invention, each interpolator increases the time resolution by a factor of two. The different levels of the multi-resolution decomposition system produce a sequence of speech samples at successively higher time resolutions. The system depicted in FIG. 5 contains two interpolation stages creating two extra levels of resolution. The samples corresponding with those higher resolutions are stored in interpolation buffers 5110 and 5210 whose sizes are suited for the designed signal processing actions. For example, if the input signal has a sample frequency of F, then the sample frequency of the signal after one interpolation stage is doubled to 2F, after two interpolation stages 4F and so on.

The multi-resolution decomposition system for higher resolutions includes a series of interpolators 5020 and 5120, decimators 50140 and 5040, and a series of sample buffers 5210, 5110, 5130 and 5230. Because a correct phase alignment between the successively interpolated signal streams is very important for the local search 5091 and 5092, and overlap-add 505 operations, linear phase filters are preferred for low-pass filtering the speech after upsampling. An efficient implementation of the linear phase interpolator-by-two may be realized by a half-band low-pass filter polyphase implementation. Because the outputs of the high time resolution interpolators 5110 and 5120, and decimators 5040 and 5140 are used for sound generation, the order of their respective filters is usually higher than the filter order of the decimation filters that realize waveforms of lower time resolution than the input resolution.

Synchronization fine-tuning continues after the input resolution is obtained by a series of local synchronization modules 5091 and 5092 operating on signal representations that correspond to successively higher time resolutions. These signal representations are stored in the interpolation buffers 5110, 5130, 5210 and 5230. When the highest resolution synchronization module 5092 is finished, the window positions are known with high (intra-sample) time resolution. The samples that are generated by means of overlap-and-add 505 are shifted back in the interpolation buffer 5230. These samples are reduced in several lower resolution levels by means of a series of decimators 5140, 5040, 504, etc.

The waveform representations that belong to the intermediate resolution levels are stored in buffers 5230, 5130, 503, etc. The waveforms stored in those buffers are used for the following synchronization operations. In FIG. 5, the speech sample generator is branched on output buffer 503, a buffer that contains a digital waveform representation at the input time resolution (although this is no requirement). Any of the buffers 5230, 5130, 503, etc. can be used to provide output samples to the speech sample generator 14 in FIG. 1 if this is advantageous for the application. The results of the signal analysis that are obtained can be applied in either the reproduction or the coding of the digital signal analyzed.

Representative embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Representative embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention. Those of ordinary skill in the art will appreciate that the present invention can be embodied in other specific forms without departing from the spirit or essential characteristics thereof. For example, while specifically described in the context of speech rate modification, the principles of the invention are equally applicable to other one dimensional signals such as animal sounds, musical instrument sounds, etc. The presently disclosed embodiments are therefore considered in all respects to be illustrative, and not restrictive. The appended claims, rather than the foregoing description indicate the scope of the invention, and all changes that come within the meaning and range of equivalents thereof are intended to be embraced therein.

### Glossary

In the framework of resolution manipulation we have chosen to use the following terminology used in N. J. Fliege, “Multirate Digital Signal Processing”, John Wiley & Sons, 1994, and incorporated herein by reference:

Decimation

Downsampling

Interpolation

Upsampling

What is claimed is:

1. A system for generating a time scale modification of a digital waveform comprising:
a) a digital waveform provider that produces an input digital waveform at a first time resolution, the digital waveform being a sequence of overlapping speech segment windows; and
b) a time-domain time scale modification process that overlap adds selected windows from the input digital waveform to create an output digital waveform representing a time scale modification of the input digital waveform, the process operating at a second time resolution lower than the first time resolution to determine the relative positions between adjacent windows in the output digital waveform.

2. A system for generating a time scale modification of a digital waveform according to claim 1, wherein the time scale modification process uses a digital decimation process to operate at the second time resolution.

3. A system for generating a time scale modification of a signal according to claim 2, wherein the digital decimation process is based on a decimation factor that is a power of two.

4. A system for generating a time scale modification of a digital waveform according to claim 1, wherein the second time resolution is successively increased to determine the relative positions between adjacent windows in the output digital waveform.

5. A system for generating a time scale modification of a digital waveform according to claim 4, wherein digital decimators are used to determine the different values of the second time resolution.

6. A system for generating a time scale modification of a digital waveform according to claim 5, wherein the digital decimators are based on decimation factors that are powers of two.

7. A system for generating a time scale modification of a digital waveform according to claim 4, wherein digital decimators reduce the second time resolution, and interpolators increase the second time resolution.

8. A system for generating a time scale modification of a digital waveform according to claim 7, wherein the digital decimators and interpolators change the second time resolution by powers of two.

9. A system for generating a time scale modification of a digital waveform according to any of claims 1 to 8, wherein the digital waveform provider is a system that generates digital speech waveforms.

10. A digital waveform coder that compresses speech by the use of a time scale modifier according to any of claims 1 to 8.

11. A digital decoder that decompresses speech by the use of a time scale modifier according to any of claims 1 to 8.
